(19) United States
(12) Patent Application Publication
(10) Pub. No.: US 2026/0316712 A1
(43) Pub. Date: Oct. 15, 2026

(54) WEBBING WINDING DEVICE

(71) Applicant: KABUSHIKI KAISHA TOKAI-RIKA-DENKI-SEISAKUSHO, Aichi-ken (JP)

(72) Inventors: Yuta SUZUKI, Aichi (JP); Yoshiteru SAKAGUCHI, Aichi (JP)

(73) Assignee: KABUSHIKI KAISHA TOKAI-RIKA-DENKI-SEISAKUSHO, Aichi-ken (JP)

(21) Appl. No.: 19/639,405

(22) Filed: Apr. 6, 2026

(30) Foreign Application Priority Data
Apr. 10, 2025 (JP) 2025-065254

(51) Int. Cl. B60R 22/34; B60R 22/12

(52) U.S. Cl. CPC B60R 22/34; B60R 22/12

(57) ABSTRACT

There is provided a webbing winding device in which a moving member is moved, and a spool is rotated in a winding direction of webbing. Here, a switching mechanism switches between deformation and non-deformation of a torsion shaft by movement of the moving member. Therefore, a rotational force of the spool is decreased by the deformation of the torsion shaft, and the rotational force of the spool is not decreased by the non-deformation of the torsion shaft, so that the rotational forces of the spool by the movement of the moving member can be switched.

### CROSS-REFERENCE TO RELATED APPLICATION

This application is based on and claims priority under 35 USC 119 from Japanese Patent Application No. 2025-65254 filed on Apr. 10, 2025, the disclosure of which is incorporated by reference herein.

### BACKGROUND

### Technical Field

The present invention relates to a webbing winding device in which a moving member is moved to rotate a spool in a winding direction.

### Related Art

In a webbing winding device described in Japanese Patent Application Laid-Open (JP-A) No. 2017-218093, a moving member is moved to rotate a spool in a winding direction.

Here, in this webbing winding device, a rotational force of the spool by the movement of the moving member is maintained constant.

### SUMMARY

In view of the above-described fact, an object of the present invention is to obtain a webbing winding device capable of switching to a rotational force of a spool by moving a moving member.

A webbing winding device of a first aspect of the present invention includes: a spool around which webbing fastened to an occupant is wound by being rotated in a winding direction; a moving member that is moved to rotate the spool in the winding direction; a deformation member that is deformable by movement of the moving member; and a switching mechanism that switches between deformation and non-deformation of the deformation member by the movement of the moving member.

In the webbing winding device of the first aspect of the present invention, the spool is rotated in the winding direction, and the webbing fastened to the occupant is wound around the spool. The moving member is moved, and the spool is rotated in the winding direction.

Here, the switching mechanism switches between deformation and non-deformation of the deformation member by the movement of the moving member. Therefore, a rotational force of the spool is decreased by the deformation of the deformation member, and the rotational force of the spool is not decreased by the non-deformation of the deformation member, so that the rotational force of the spool can be switched by the movement of the moving member.

4. The webbing winding device according to claim 2, wherein the switching mechanism includes:
a communication member by which the deformation member communicates with the moving member, and
a restriction member that switches between restriction and non-restriction of communication of the deformation member with the moving member by the communication member.

According to a webbing winding device of a second aspect of the present invention, in the webbing winding device of the first aspect of the present invention, the switching mechanism switches between communication and non-communication of the deformation member with the moving member.

In the webbing winding device of the second aspect of the present invention, the switching mechanism switches between communication and non-communication of the deformation member with the moving member. Therefore, the deformation member is deformable by the communication of the deformation member with the moving member, and the deformation member can be made non-deformable by the non-communication of the deformation member with the moving member.

According to a webbing winding device of a third aspect of the present invention, in the webbing winding device of the second aspect of the present invention, the deformation member communicates with the moving member via the spool.

In the webbing winding device of the third aspect of the present invention, the deformation member communicates with the moving member via the spool. Therefore, a degree of freedom of arrangement of the deformation member can be increased.

According to a webbing winding device of a fourth aspect of the present invention, in the webbing winding device of the second or third aspect of the present invention, the switching mechanism includes: a communication member by which the deformation member communicates with the moving member, and a restriction member that switches between restriction and non-restriction of communication of the deformation member with the moving member by the communication member.

In the webbing winding device of the fourth aspect of the present invention, the switching mechanism includes the communication member and the restriction member, and the restriction and the non-restriction of the communication of the deformation member with the moving member by the communication member are switched by the restriction member. Therefore, the deformation member can communicate with the moving member, and the deformation member can be incommunicable with the moving member.

According to a webbing winding device of a fifth aspect of the present invention, in the webbing winding device of the first aspect of the present invention, the switching mechanism switches between fixing and non-fixing of the deformation member.

In the webbing winding device of the fifth aspect of the present invention, the switching mechanism switches between fixing and non-fixing of the deformation member. Therefore, the fixing of the deformation member enables the deformation member to be deformed, and the non-fixing of the deformation member enables the deformation member to be non-deformable.

According to a webbing winding device of a sixth aspect of the present invention, in the webbing winding device of any one of the first to fifth aspects of the present invention, the deformation member is twisted and deformed.

In the webbing winding device of the sixth aspect of the present invention, the deformation member is twisted and deformed. Therefore, a load for deforming the deformation member can be increased.

### BRIEF DESCRIPTION OF THE DRAWINGS

Exemplary embodiments of the present invention will be described in detail based on the following figures, wherein:

FIG. 1 is a perspective view from obliquely behind and a right side, the view illustrating a webbing winding device according to a first embodiment of the present invention;

FIG. 2 is a cross-sectional view from a left-hand direction, the view illustrating a pretensioner mechanism of the webbing winding device according to the first embodiment of the present invention;

FIG. 3 is a left side view from the left-hand direction, the view illustrating a switching mechanism of the webbing winding device according to the first embodiment of the present invention;

FIG. 4 is a cross-sectional view from the left-hand direction, the view illustrating the switching mechanism of the webbing winding device according to the first embodiment of the present invention;

FIG. 5A is a perspective view from obliquely behind and the right side, the view illustrating a state in which the switching mechanism of the webbing winding device according to the first embodiment of the present invention is not in operation;

FIG. 5B is a perspective view from obliquely behind and the right side, the view illustrating a state in which the switching mechanism of the webbing winding device according to the first embodiment of the present invention is in operation;

FIG. 6A is a perspective view from an obliquely below and a rear side, the view illustrating the state in which the switching mechanism of the webbing winding device according to the first embodiment of the present invention is in operation;

FIG. 6B is a left side view from the left-hand direction, the view illustrating the state in which the switching mechanism of the webbing winding device according to the first embodiment of the present invention is in operation;

FIG. 7 is a perspective view from a left side, the view illustrating a torsion shaft and the like of the webbing winding device according to the first embodiment of the present invention;

FIG. 8A is a cross-sectional view illustrating a state in which the torsion shaft is not deformed among the torsion shaft and the like of the webbing winding device according to the first embodiment of the present invention;

FIG. 8B is a cross-sectional view illustrating a state in which the torsion shaft is deformed among the torsion shaft and the like of the webbing winding device according to the first embodiment of the present invention;

FIG. 9A is a perspective view from the left side, the view illustrating a coiled wave spring and the like of a webbing winding device according to a modification example of the first embodiment of the present invention;

FIG. 9B is a perspective view illustrating the coiled wave spring of the webbing winding device according to the modification example of the first embodiment of the present invention;

FIG. 10A is a cross-sectional view illustrating a state in which the coiled wave spring is not deformed among the coiled wave spring and the like of the webbing winding device according to the modification example of the first embodiment of the present invention;

FIG. 10B is a cross-sectional view illustrating a state in which the coiled wave spring is deformed among the coiled wave spring and the like of the webbing winding device according to the modification example of the first embodiment of the present invention;

FIG. 11 is a cross-sectional view from the left-hand direction, the view illustrating a pretensioner mechanism of a webbing winding device according to a second embodiment of the present invention;

FIG. 12 is a cross-sectional view from the left-hand direction, the view illustrating a state in which a switching mechanism of the webbing winding device according to the second embodiment of the present invention is in operation;

FIG. 13A is a bottom view from below, the view illustrating a state in which the switching mechanism and the like of the webbing winding device according to the second embodiment of the present invention are not in operation;

FIG. 13B is a bottom view from below, the view illustrating a state in which the switching mechanism and the like of the webbing winding device according to the second embodiment of the present invention are in operation;

FIG. 14 is a cross-sectional view from the left-hand direction, the view illustrating a pretensioner mechanism of a webbing winding device according to a third embodiment of the present invention;

FIG. 15 is a cross-sectional view from the left-hand direction, the view illustrating a pretensioner mechanism of a webbing winding device according to a fourth embodiment of the present invention;

FIG. 16A is a top view from above, the view illustrating a state in which a switching mechanism and the like of the webbing winding device according to the fourth embodiment of the present invention are not in operation;

FIG. 16B is a top view from above, the view illustrating a state in which the switching mechanism and the like of the webbing winding device according to the fourth embodiment of the present invention are in operation; and

FIG. 17 is a cross-sectional view from the left-hand direction, the view illustrating a pretensioner mechanism of a webbing winding device according to a fifth embodiment of the present invention.

### DETAILED DESCRIPTION

### First Embodiment

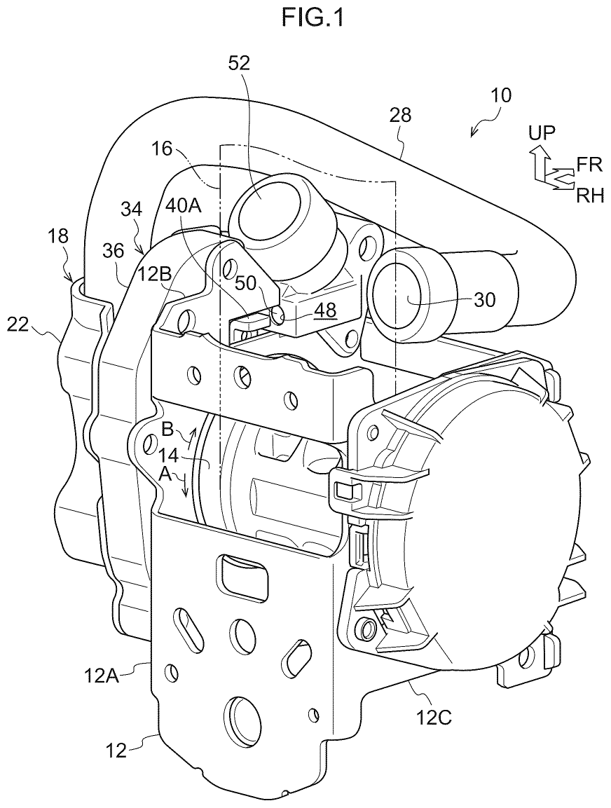

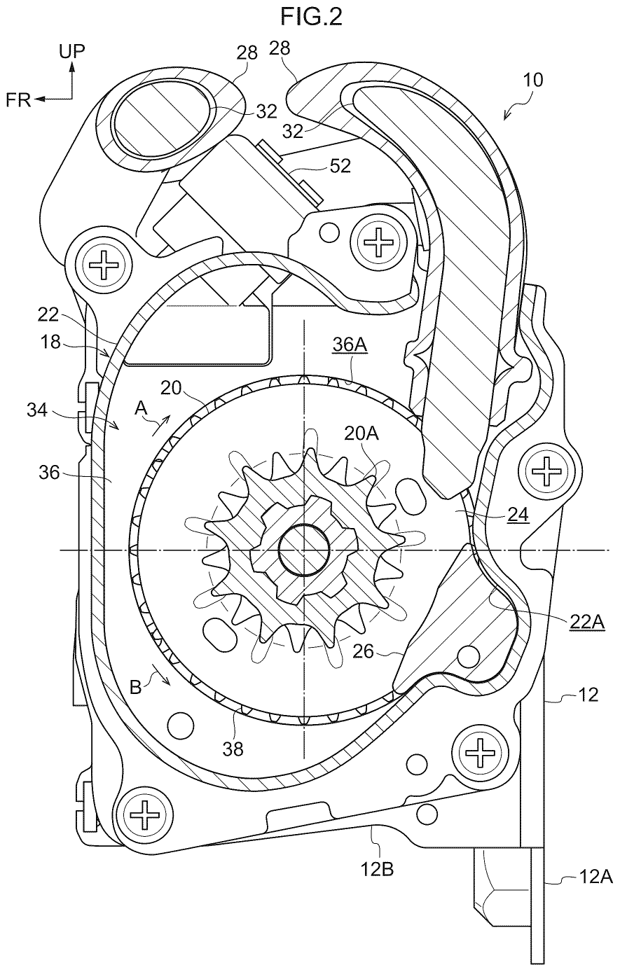

FIG. 1 is a perspective view from obliquely behind and a right side, the view illustrating a webbing winding device 10 according to a first embodiment of the present invention. FIG. 2 is a cross-sectional view from the left, the view illustrating the webbing winding device 10. In the figures, a frontward direction of the webbing winding device 10 is represented by an arrow FR, a right-hand direction of the webbing winding device 10 is represented by an arrow RH, and an upward direction of the webbing winding device 10 represented by an arrow UP.

The webbing winding device 10 according to this embodiment is included in a seat belt device, and the seat belt device is applied to a vehicle seat (not illustrated). The seat includes a sensor, and the sensor detects a physique (for example, weight) of an occupant seated on the seat.

As illustrated in FIGS. 1 and 2, the webbing winding device 10 includes a frame 12 having a substantially U-shaped cross section, and a back plate 12A, a leg plate 12B, and a leg plate 12C are provided on a rear side, a left side, and a right side of the frame 12, respectively.

A substantially cylindrical spool 14 is rotatably supported between the leg plate 12B and the leg plate 12C of the frame 12, and an axial direction of the spool 14 is set in a left-right direction.

A long belt-shaped webbing 16 is wound around the spool 14 from a proximal end side in a longitudinal direction of the webbing, and the spool 14 is rotated in a winding direction A (see FIG. 1 and the like) to wind the webbing 16 around the spool 14, and the spool 14 is rotated in an unwinding direction B (see FIG. 1 and the like) to unwind the webbing 16 from the spool 14. The webbing 16 is unwound upward from the spool 14 and is fastened on the occupant seated on the seat.

A pretensioner mechanism 18 is provided on a left side of the frame 12.

The pretensioner mechanism 18 includes a metal rotation member 20 having a substantially circular column shape, and the rotation member 20 is coaxially arranged on a left side of the spool 14 and is connected to the spool 14 to be rotatable in an integrated manner. A plurality of substantially triangular prism-shaped engagement teeth 20A as engagement portions are integrally provided on an outer circumference of an intermediate portion of the rotation member 20 in an axial direction thereof, and the plurality of engagement teeth 20A are arranged at equal intervals in a circumferential direction of the rotation member 20. The engagement teeth 20A protrude outward in a radial direction of the rotation member 20, and the engagement teeth 20A decrease in dimension in the circumferential direction of the rotation member 20 as the engagement teeth 20A extend outward in the radial direction of the rotation member 20. Both end portions of the rotation member 20 in the axial direction are coaxially enlarged in diameter, and the engagement teeth 20A are arranged between both the end portions of the rotation member 20 in the axial direction.

A metal cover plate 22 having a substantially rectangular parallelepiped box shape as a route body is fixed to the left side of the frame 12 via a switching case 36 to be described below, and an inside of the cover plate 22 is open to a right side. A lower wall and a front part of an upper wall of the cover plate 22 are curved in a recess shape toward an outer circumferential side of the cover plate 22 in a front-rear direction. An arrangement recess portion 22A having a substantially rectangular parallelepiped shape is formed in a lower portion of a rear wall of the cover plate 22, a front side of the arrangement recess portion 22A is open in the cover plate 22, and a left side and a right side thereof are closed by a bottom wall (left wall) of the cover plate 22 and the switching case 36 to be described below, respectively. A movement route 24 is formed from a rear portion via a lower portion and a front portion to an upper portion in the cover plate 22, and the side walls (the rear wall (excluding the arrangement recess portion 22A), the lower wall, the front wall, and the upper wall) of the cover plate 22 form the movement route 24.

In the arrangement recess portion 22A, a metal guide 26 having a substantially rectangular parallelepiped shape as a route member is arranged, and the guide 26 is fitted and fixed in the arrangement recess portion 22A. A front surface of the guide 26 is a part of a rear surface in the cover plate 22, and the front surface of the guide 26 forms the movement route 24 in the cover plate 22 on a rear side of the rear portion in the cover plate 22.

A metal cylinder 28 having a substantially cylindrical shape as a guide body is arranged on an upper side of the frame 12, and the cylinder 28 is bent at a plurality of locations in an intermediate portion in the axial direction thereof. A distal end portion of the cylinder 28 in an axial direction thereof extends downward and is fixed between a rear portion of the switching case 36 to be described below and a rear portion of the cover plate 22, and an inside of the distal end portion of the cylinder 28 in the axial direction is open downward at a part on an upper and rear side in the cover plate 22.

An MGG 30 (a micro gas generator) as a moving device is inserted and fixed in a proximal end portion of the cylinder 28 in the axial direction. When the MGG 30 is operated, the MGG 30 instantaneously generates high-pressure gas and supplies the high-pressure gas into the cylinder 28.

In the cylinder 28, a moving member 32 having a substantially long circular column shape is arranged on a distal end side in the axial direction with respect to the MGG 30, and the moving member 32 is made of a resin, has flexibility, and is substantially fitted in the cylinder 28.

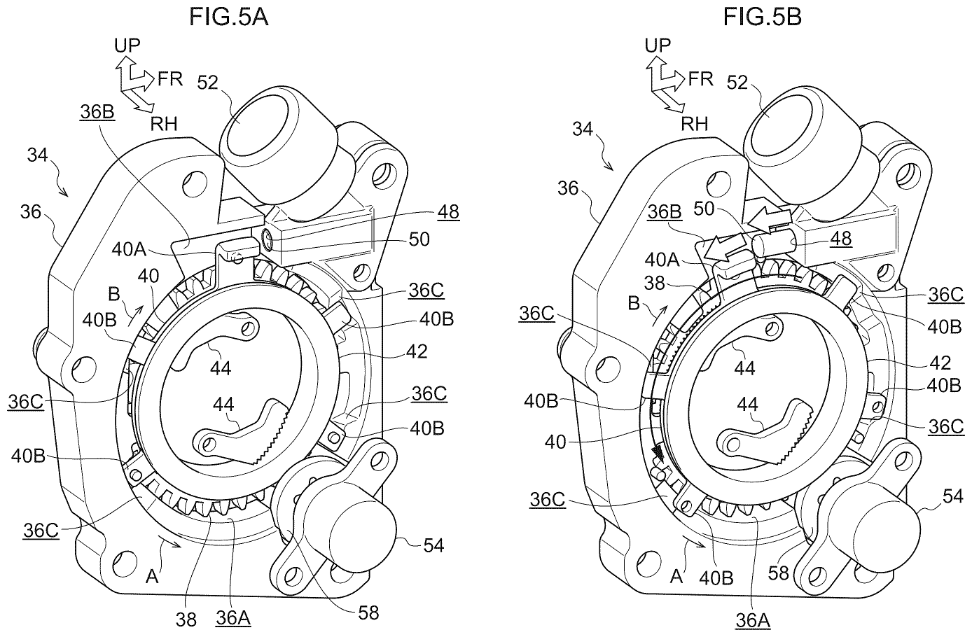

On the left side of the frame 12, a switching mechanism 34 (see FIG. 5A) is arranged on a right side of the cover plate 22.

The switching mechanism 34 includes the metal switching case 36 having a substantially rectangular parallelepiped shape as an arrangement body, the switching case 36 is fixed to a left side of the leg plate 12B of the frame 12, and the cover plate 22 is fixed to a left side of the switching case. A circular column-shaped arrangement hole 36A is formed to penetrate the switching case 36, and the arrangement hole 36A is arranged coaxially with the rotation member 20. In the switching case 36, an operation recess portion 36B having a substantially rectangular column shape is formed on an upper side of the arrangement hole 36A, and the operation recess portion 36B is open to the right side and the arrangement hole 36A side. In the switching case 36, a plurality of (four in this embodiment) moving recess portions 36C having a substantially trapezoidal column shape are formed around the arrangement hole 36A, and the plurality of moving recess portions 36C are arranged at substantially equal intervals in a circumferential direction of the arrangement hole 36A. The moving recess portion 36C is open toward the right side and the arrangement hole 36A side, and a side surface of the moving recess 36C in the winding direction A is inclined in a direction toward the right side along the winding direction A.

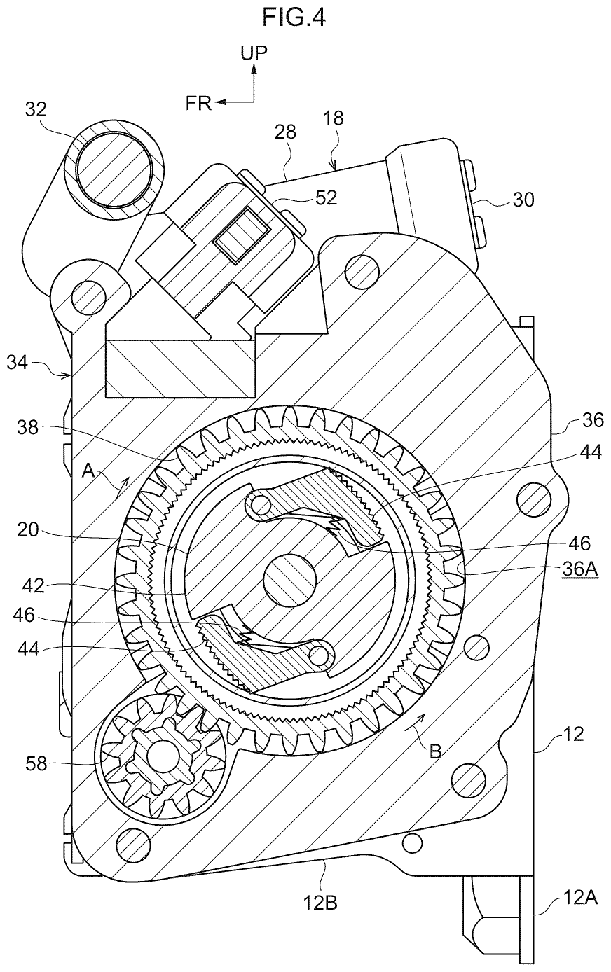

A metal transmission gear 38 (see FIG. 4) having an annular shape as a transmission member is fitted in the arrangement hole 36A of the switching case 36, and the transmission gear 38 is rotatably supported on a circumferential surface of the arrangement hole 36A. An inner circumferential surface of the transmission gear 38 is knurled, and pits and projections in a circumferential direction are formed in the inner circumferential surface of the transmission gear 38.

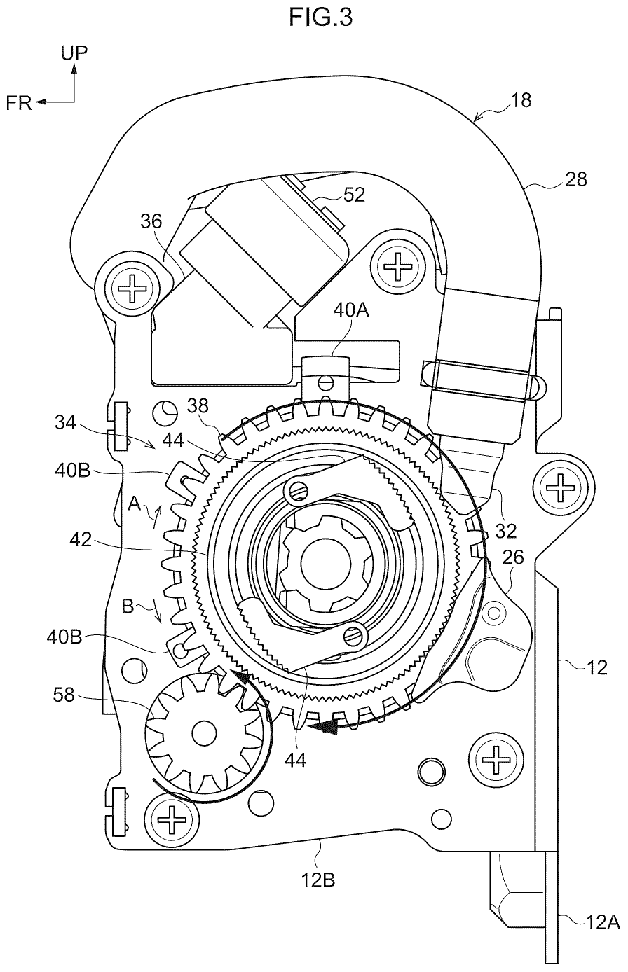

In the arrangement hole 36A of the switching case 36, a metal pawl 40 (see FIG. 3) having a substantially annular plate shape as a switching member is coaxially arranged on a right side of the transmission gear 38. An operation piece 40A having an L-shaped cross section is integrally provided on an upper side of the pawl 40, and a proximal end part of the operation piece 40A protrudes upward and a distal end part of the operation piece 40A protrudes rightward. The operation piece 40A is inserted into the operation recess portion 36B of the switching case 36, and the operation piece 40A is rotatable in the winding direction A. A plurality of (four in this embodiment) moving pieces 40B having a rectangular plate shape are integrally provided on a circumferential portion of the pawl 40, and the plurality of moving pieces 40B are arranged at substantially equal intervals in a circumferential direction of the pawl 40 and protrude outward in a radial direction of the pawl 40. The moving piece 40B is inserted into the moving recess portion 36C of the switching case 36, and rotation of the moving piece 40B in the winding direction A and the unwinding direction B is restricted.

In the arrangement hole 36A of the switching case 36, a metal restriction ring 42 (see FIG. 3) having an annular shape as a restriction member is coaxially arranged on a right side of the pawl 40, and the restriction ring 42 has an L-shaped cross section. An outer part of the restriction ring 42 is formed in an annular plate shape, and the outer part of the restriction ring 42 abuts the pawl 40. An inner part of the restriction ring 42 is formed in a cylindrical shape, and the inner part of the restriction ring 42 covers the inner circumferential surface of the transmission gear 38.

A plurality of (two in this embodiment) metal clutches 44 (see FIG. 4) having a substantially L-shaped plate shape as a communication member are arranged on an inner side of the restriction ring 42 in a radial direction, and the plurality of clutches 44 are arranged at equal intervals in a circumferential direction of the restriction ring 42 and are supported on the right side of the rotation member 20 at respective proximal end portions to be rotatable in a predetermined range. A distal end surface of the clutch 44 is knurled, and pits and projections in a longitudinal direction are formed in the distal end surface of the clutch 44. A compression coil spring 46 as a communication biasing member is suspended between the clutch 44 and the right side of the rotation member 20, and the compression coil spring 46 biases the clutch 44 to abut the inner part of the restriction ring 42. Therefore, rotation of the clutch 44 due to a biasing force of the compression coil spring 46 is restricted by the restriction ring 42, and meshing of the distal end surface of the clutch 44 with the inner circumferential surface of the transmission gear 38 is restricted.

An operation hole 48 having a circular column shape is formed in an upper portion of the switching case 36, and the operation hole 48 extends in the front-rear direction and is open rearward. A metal piston 50 having a circular column shape as an operation member is movably fitted in the operation hole 48, and the distal end part of the operation piece 40A of the pawl 40 faces a rear side of the piston 50. A switching MGG 52 (a switching micro gas generator) as a switching device is fixed to an upper side of the switching case 36, and the switching MGG 52 communicates with a front side of the operation hole 48. When the switching MGG 52 is operated, the switching MGG 52 instantaneously generates high-pressure gas and supplies the gas to the operation hole 48.

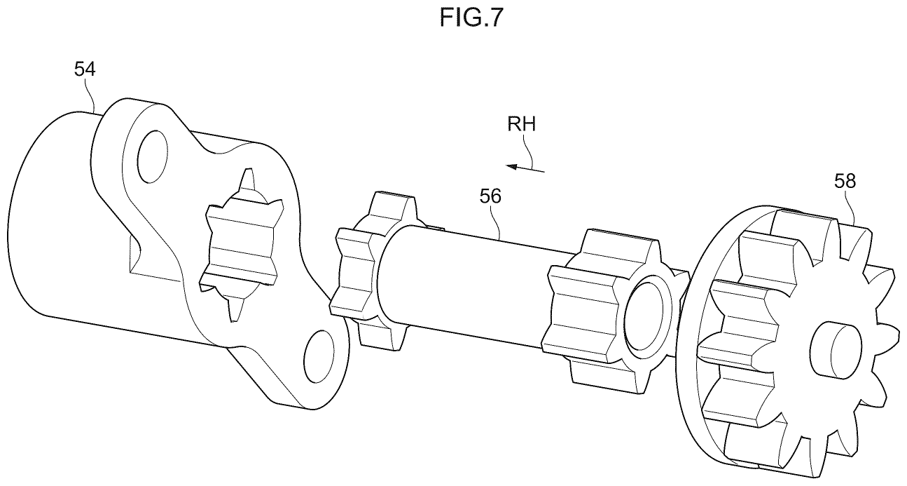

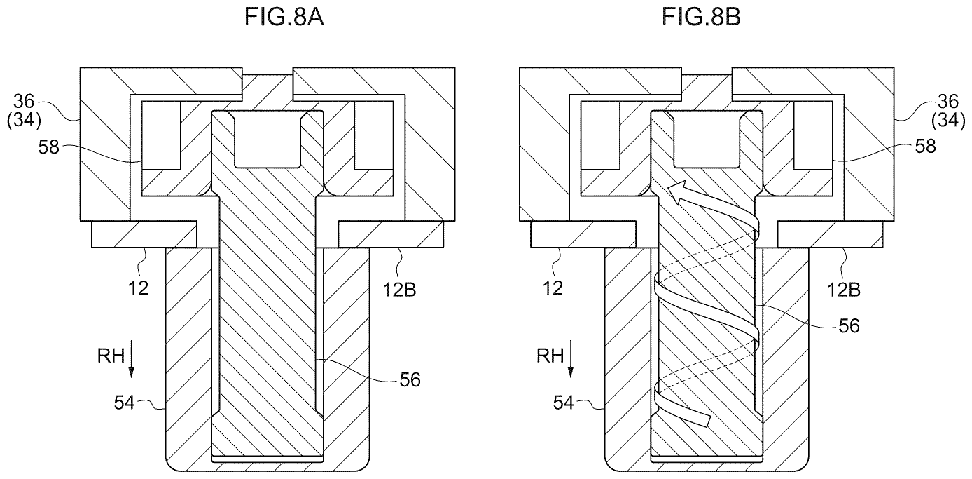

A metal fixed cylinder 54 (see FIGS. 7 and 8A) having a substantially bottomed cylindrical shape as a fixed member is fixed to a right side of the leg plate 12B of the frame 12, obliquely below and a front side of the spool 14, and an inside of the fixed cylinder 54 is open to the left side. A metal torsion shaft 56 having a substantially circular column shape as a deformation member is coaxially inserted into the fixed cylinder 54, and a right end portion of the torsion shaft 56 non-rotatably engages with the fixed cylinder 54. The torsion shaft 56 rotatably penetrates the leg plate 12B, and a metal engagement gear 58 as an engagement member is coaxially fixed to a left end portion of the torsion shaft 56 to be rotatable in an integrated manner. The engagement gear 58 is inserted into the switching case 36 and is rotatably supported therein, and the engagement gear 58 meshes with the transmission gear 38.

Next, operations of this embodiment will be described.

In the webbing winding device 10 having the above-described configuration, at the time of collision of the vehicle (at the time of collision detection), the MGG 30 is operated in the pretensioner mechanism 18, and the MGG 30 instantaneously supplies high-pressure gas into the cylinder 28, so that the moving member 32 in the cylinder 28 is moved to a distal end side of the cylinder 28 in the axial direction by the pressure of the gas and extends downward from a distal end of the cylinder 28 in the axial direction. When the moving member 32 is moved in the cover plate 22, along the side walls of the cover plate 22, the moving member 32 is moved downward at a rear portion in the cover plate 22, moved frontward at a lower portion in the cover plate 22, moved upward at a front portion in the cover plate 22, and moved rearward at an upper portion in the cover plate 22 to be moved along the moving path 24 in the cover plate 22.

When the moving member 32 is moved downward at the rear portion in the cover plate 22, the moving member 32 passes downward between a rear portion of the intermediate portion of the rotation member 20 in the axial direction and the guide 26 on the rear wall of the cover plate 22, and the engagement teeth 20A on a rear portion of the rotation member 20 engage with (project into) the moving member 32, so that the rotation member 20 is rotated in the winding direction A by the moving member 32, and the spool 14 is rotated in the winding direction A in an integrated manner with the rotation member 20. Therefore, the webbing 16 is wound around the spool 14, and a restraint force on the occupant by the webbing 16 is increased. The moving member 32 does not engage with the engagement teeth 20A at a position after passing between the rear portion of the intermediate portion of the rotation member 20 in the axial direction and the guide 26.

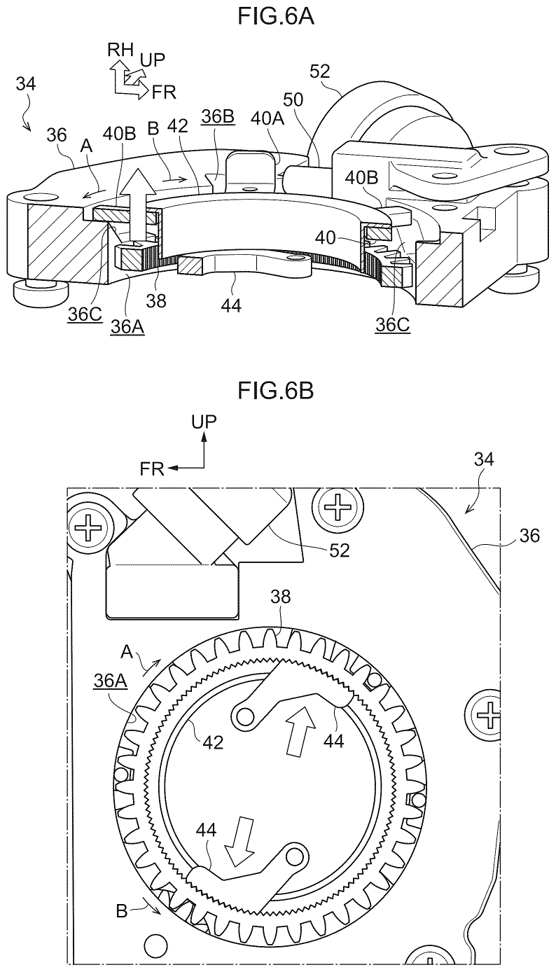

At the time of collision of the vehicle when a sensor of a seat detects that the occupant has a small build (at the time of collision detection), the switching MGG 52 is operated in the switching mechanism 34, and the switching MGG 52 instantaneously supplies high-pressure gas to the operation hole 48 of the switching case 36, so that the piston 50 in the operation hole 48 is moved rearward by a pressure of the gas, and the operation piece 40A of the pawl 40 is rotated in the winding direction A by the piston 50 (see FIG. 5B). Therefore, when the moving pieces 40B of the pawl 40 are rotated in the winding direction A and are moved to the right side by the side surfaces of the moving recess portions 36C of the switching case 36 in the winding direction A, the restriction ring 42 is moved to the right side by the pawl 40, and restriction of rotation of the clutches 44 by the inner part of the restriction ring 42 is cancelled (see FIG. 6A). When the clutches 44 are rotated by the biasing force of the compression coil spring 46, and the distal end surfaces of the clutches 44 mesh with the inner circumferential surface of the transmission gear 38 (see FIG. 6B), the transmission gear 38 is rotated in the winding direction A in an integrated manner with the rotation member 20, and the engagement gear 58 is rotated by the transmission gear 38. Therefore, when the torsion shaft 56 communicates with the moving member 32, and the left end portion of the torsion shaft 56 is rotated in an integrated manner with the engagement gear 58, the torsion shaft 56 is twisted and deformed (see FIG. 8B), and a load for twisting and deforming the torsion shaft 56 is applied to the rotation member 20 and the spool 14. This enables a rotational force of the rotation member 20 and the spool 14 in the winding direction A by the movement of the moving member 32 to be decreased, and enables a winding force of the webbing 16 around the spool 14 to be decreased (depowered), thereby enabling a restraint force on an occupant of small build by the webbing 16 to be appropriate.

At the time of collision of the vehicle when the sensor of the seat detects that the occupant has a large build (at the time of collision detection), the switching MGG 52 is not operated in the switching mechanism 34, so that meshing of the distal end surfaces of the clutches 44 with the inner circumferential surface of the transmission gear 38 is restricted by the restriction ring 42 (see FIG. 3), and the torsion shaft 56 does not communicate with the moving member 32. This enables the rotational force of the rotation member 20 and the spool 14 in the winding direction A by the movement of the moving member 32 to be increased, and enables the winding force of the webbing 16 around the spool 14 to be increased (high-powered), thereby enabling a restraint force on an occupant of large build by the webbing 16 to be appropriate.

Here, in the switching mechanism 34, deformation and non-deformation of the torsion shaft 56 by the movement of the moving member 32 are switched by switching operation and non-operation of the switching MGG 52. Therefore, a rotational force of the spool 14 is decreased by the deformation of the torsion shaft 56, and the rotational force of the spool 14 is not decreased by the non-deformation of the torsion shaft 56, so that the rotational forces of the rotation member 20 and the spool 14 by the movement of the moving member 32 can be switched.

Further, the switching mechanism 34 switches between communication and non-communication of the torsion shaft 56 with the moving member 32. Therefore, the torsion shaft 56 can be deformed by the communication of the torsion shaft 56 with the moving member 32, and the torsion shaft 56 can be made non-deformable by the non-communication of the torsion shaft 56 with the moving member 32.

Furthermore, in the switching mechanism 34, restriction and non-restriction of the meshing of the clutches 44 with the transmission gear 38 by the restriction ring 42 are switched by the switching MGG 52, and restriction and non-restriction of the communication of the torsion shaft 56 with the moving member 32 are switched. Therefore, the torsion shaft 56 can communicate with the moving member 32, and the torsion shaft 56 can be made uncommunicable with the moving member 32. The switching MGG 52 only needs to move the piston 50 to move the pawl 40 and the restriction ring 42. Therefore, an output of the switching MGG 52 can be reduced, and costs of the switching MGG 52 can be reduced.

The torsion shaft 56 communicates with the moving member 32 via the rotation member 20 integrated with the spool 14. Therefore, a degree of freedom of arrangement of the torsion shaft 56 can be increased.

Further, the torsion shaft 56 is twisted and deformed. Therefore, the load for deforming the torsion shaft 56 can be increased, and the torsion shaft 56 can be decreased in size, so that the webbing winding device 10 can be downsized. Furthermore, when a diameter of the torsion shaft 56 is adjusted, the load for deforming the torsion shaft 56 can be finely adjusted, and a decrease amount of the winding force of the webbing 16 around the spool 14 can be finely adjusted.

### Modification Example

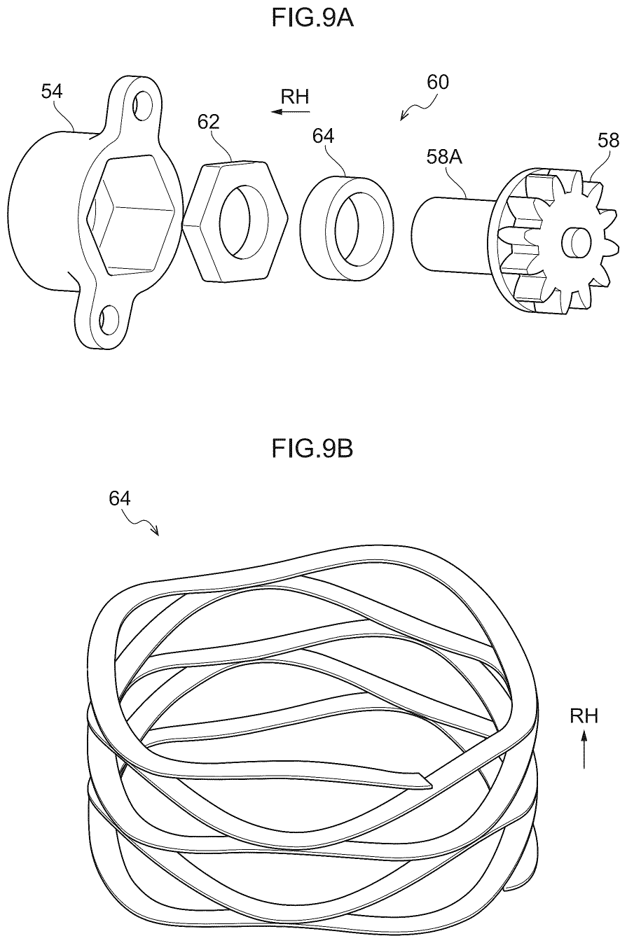

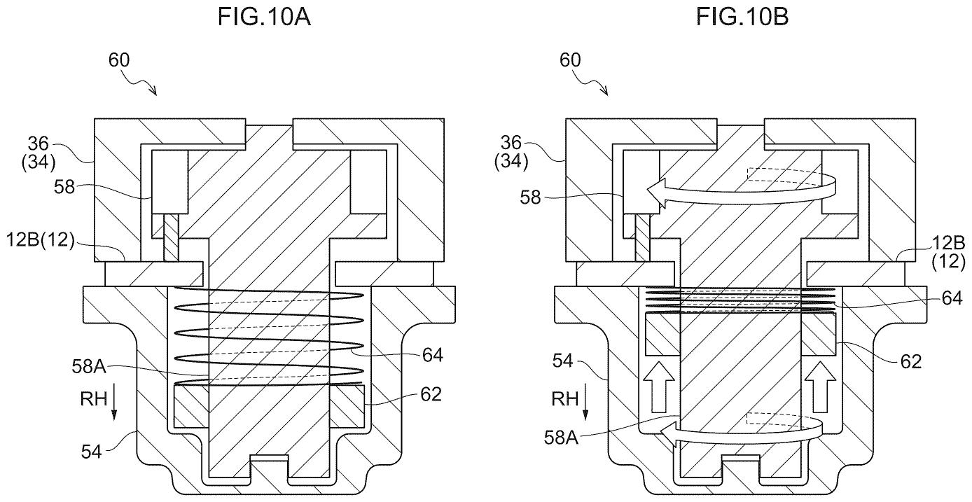

FIG. 9A is a perspective view from the left side, the view illustrating main parts of a webbing winding device 60 according to a modification example of the first embodiment, and FIG. 10A is a cross-sectional view of the main parts of the webbing winding device 60.

As illustrated in FIGS. 9A and 10A, in the webbing winding device 60 according to the modification example, a metal nut 62 having a polygonal plate shape in the external shape as a deformation member is coaxially inserted into the fixed cylinder 54, and the nut 62 non-rotatably engages with the fixed cylinder 54. A screw 58A having a substantially circular column shape is integrally provided on a right side of the engagement gear 58, and the screw 58A is arranged coaxially with the engagement gear 58 and is rotated in an integrated manner with the engagement gear 58. The screw 58A rotatably penetrates the leg plate 12B of the frame 12, and the screw 58A is screwed in the nut 62 and is coaxially inserted into the nut 62.

The screw 58A is inserted into a metal coiled wave spring 64 (see FIG. 9B) having a substantially spiral plate shape as a deformation member, and a plate surface of the coiled wave spring 64 is directed toward an axial direction (left-right direction) of the coiled wave spring 64. The coiled wave spring 64 is curved in a wave shape in a thickness direction in a longitudinal direction (spiral direction), and a curved portion on the left side toward the right side and a curved portion on the right side toward the left side in the coiled wave spring 64 abut each other. The coiled wave spring 64 is suspended between the leg plate 12B and the nut 62, and the coiled wave spring 64 is elastically deformable in the axial direction.

Incidentally, at the time of collision of the vehicle when the sensor of the seat detects that the occupant has a small build (at the time of collision detection), the switching MGG 52 is operated in the switching mechanism 34, the transmission gear 38 is rotated in the winding direction A in an integrated manner with the rotation member 20, so that the engagement gear 58 is rotated by the transmission gear 38, and the coiled wave spring 64 communicates with the moving member 32. Therefore, when the screw 58A is rotated in an integrated manner with the engagement gear 58, and the nut 62 is moved to the left side (the leg plate 12B side), the coiled wave spring 64 is contracted and deformed in the axial direction (see FIG. 10B), and a load for contracting and deforming the coiled wave spring 64 in the axial direction is applied to the rotation member 20 and the spool 14. This enables a rotational force of the rotation member 20 and the spool 14 in the winding direction A by the movement of the moving member 32 to be decreased and enables a winding force of the webbing 16 around the spool 14 to be decreased (depowered), thereby enabling a restraint force on the occupant of small build by the webbing 16 to be appropriate.

Here, also in the modification example, the same operations and effects as those of the first embodiment can be achieved except for operations and effects due to the twisting and deformation of the torsion shaft 56.

The coiled wave spring 64 is contracted and deformed in the axial direction. Therefore, a load for deforming the coiled wave spring 64 can be increased, and the coiled wave spring 64 can be decreased in size, so that the webbing winding device 60 can be downsized.

### Second Embodiment

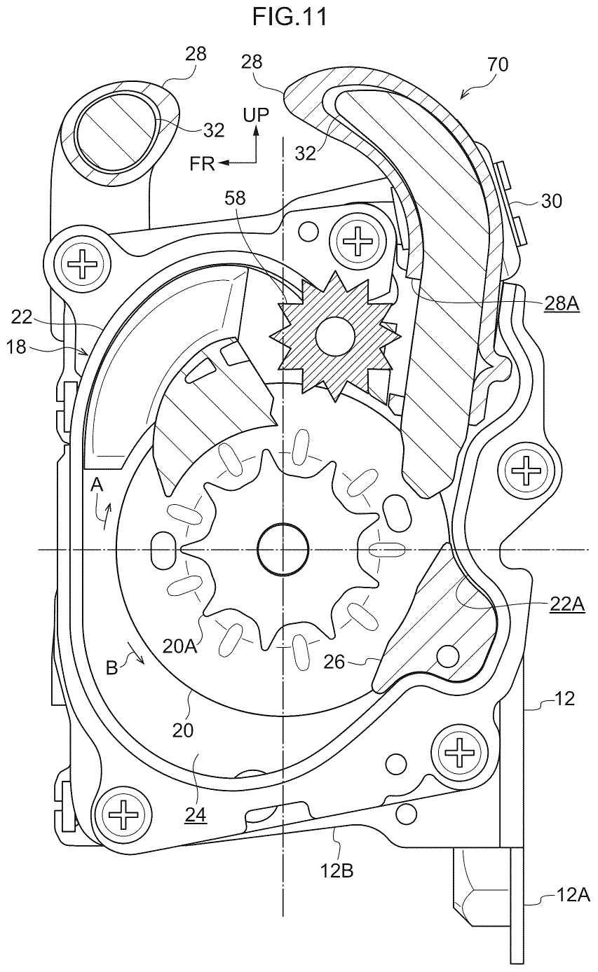

FIG. 11 is a cross-sectional view from the left-hand direction, the view illustrating a pretensioner mechanism 18 of a webbing winding device 70 according to a second embodiment of the present invention.

The webbing winding device 70 according to this embodiment has substantially the same configuration as that of the first embodiment and differs in the following points.

As illustrated in FIG. 11, in the webbing winding device 70 according to this embodiment, the switching case 36 is not provided in the switching mechanism 34. The cover plate 22 is fixed to the left side of the frame 12 (the left side of the leg plate 12B), and the distal end portion of the cylinder 28 in the axial direction is fixed between a rear portion of the leg plate 12B and the rear portion of the cover plate 22. A communication hole 28A is formed to penetrate a front portion of the distal end portion of the cylinder 28 in the axial direction, and the communication hole 28A exposes the moving member 32 in the cylinder 28 to the front side.

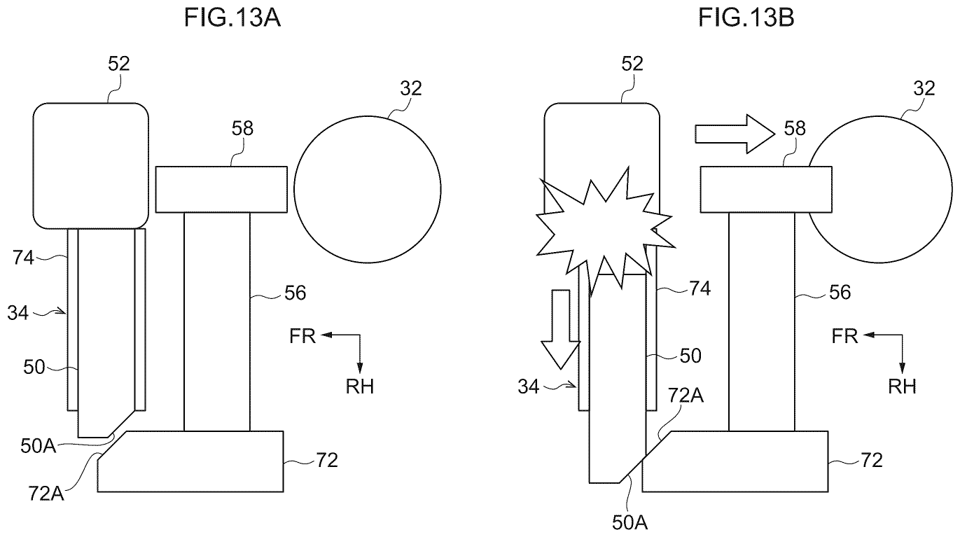

The torsion shaft 56 (see FIG. 13A) rotatably penetrates the leg plate 12B on the front side of the distal end portion of the cylinder 28 in the axial direction, and the torsion shaft 56 can be parallelly displaced rearward with respect to the leg plate 12B. A metal fixed column 72 having a substantially rectangular column shape as a fixed member is fixed to the right end portion of the torsion shaft 56, and the fixed column 72 is not rotatable with respect to the right end portion of the torsion shaft 56. The fixed column 72 is supported by the frame 12, and the fixed column 72 is movable rearward in the state of being non-rotatable with respect to the frame 12. A fixed inclined surface 72A is formed at a corner portion on the front side and the left side of the fixed column 72, and the engagement gear 58 at the left end portion of the torsion shaft 56 is arranged behind the communication hole 28A of the cylinder 28.

In the frame 12, a metal operation cylinder 74 having a rectangular cylindrical shape is supported in front of the torsion shaft 56, and the operation cylinder 74 is arranged in parallel with the torsion shaft 56. The piston 50 having a substantially rectangular column shape is movably fitted in the operation cylinder 74, and a moving inclined surface 50A is formed at a corner portion on the rear side and the right side of the piston 50. The moving inclined surface 50A faces the fixed inclined surface 72A of the fixed column 72 in the left-right direction.

The switching MGG 52 is supported by the frame 12, and the switching MGG 52 communicates with a left side in the operation cylinder 74.

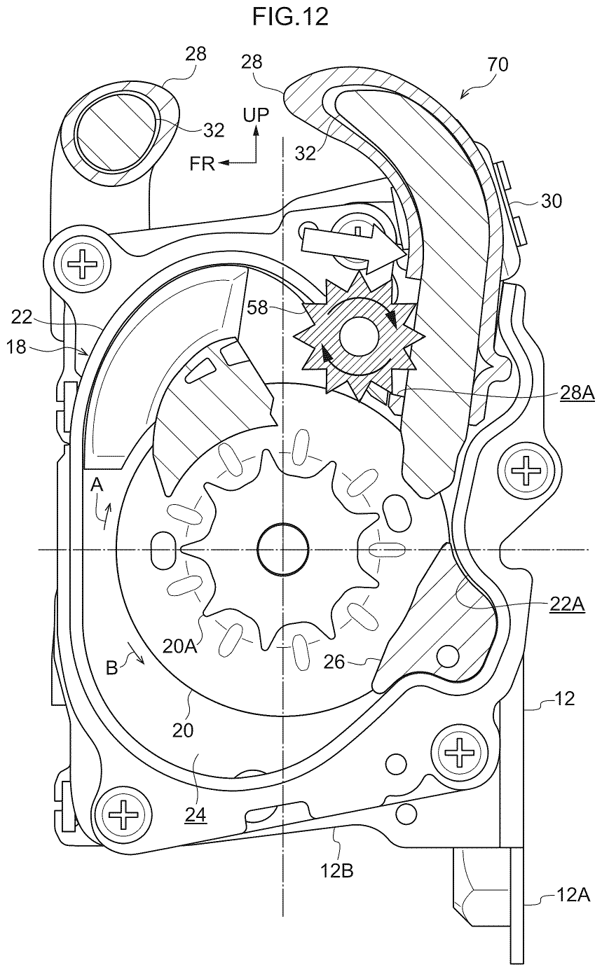

Incidentally, at the time of collision of the vehicle when the sensor of the seat detects that the occupant has a small build (at the time of collision detection), the switching MGG 52 is operated in the switching mechanism 34, and the switching MGG 52 instantaneously supplies high-pressure gas into the operation cylinder 74, so that the piston 50 in the operation cylinder 74 is moved rightward by a pressure of the gas, and the fixed column 72 is moved rearward by sliding performed between the moving inclined surface 50A of the piston 50 and the fixed inclined surface 72A of the fixed column 72 (see FIG. 13B). Therefore, when the torsion shaft 56 and the engagement gear 58 are moved rearward in an integrated manner with the fixed column 72, and teeth of the engagement gear 58 engage with (project into) the moving member 32 in the cylinder 28 via the communication hole 28A of the cylinder 28, the engagement gear 58 is rotated by the movement of the moving member 32 (see FIG. 12). Therefore, when the torsion shaft 56 communicates with the moving member 32, and the left end portion of the torsion shaft 56 is rotated in an integrated manner with the engagement gear 58, the torsion shaft 56 is twisted and deformed, and a load for twisting and deforming the torsion shaft 56 is applied to the moving member 32. This enables the rotational force of the rotation member 20 and the spool 14 in the winding direction A by the movement of the moving member 32 to be decreased and enables the winding force of the webbing 16 around the spool 14 to be decreased (depowered), thereby enabling the restraint force on the occupant of small build by the webbing 16 to be appropriate.

At the time of collision of the vehicle when the sensor of the seat detects that the occupant has a large build (at the time of collision detection), the switching MGG 52 is not operated in the switching mechanism 34, so that the teeth of the engagement gear 58 do not engage with the moving member 32 (see FIG. 11), and the torsion shaft 56 does not communicate with the moving member 32. This enables the rotational force of the rotation member 20 and the spool 14 in the winding direction A by the movement of the moving member 32 to be increased, and enables the winding force of the webbing 16 around the spool 14 to be increased (high-powered), thereby enabling the restraint force on the occupant of large build by the webbing 16 to be appropriate.

Here, also in this embodiment, the same operations and effects as those of the first embodiment can be achieved except for the operations and effects due to the transmission gear 38, the pawl 40, the restriction ring 42, and the clutch 44.

Further, in the switching mechanism 34, movement and non-movement of the torsion shaft 56 and the engagement gear 58 are switched by the switching MGG 52, and communication and non-communication of the torsion shaft 56 with the moving member 32 are switched. Therefore, the switching mechanism 34 can be downsized. Furthermore, the switching MGG 52 only needs to move the piston 50 to move the torsion shaft 56 and the engagement gear 58. Therefore, the output of the switching MGG 52 can be reduced, and the costs of the switching MGG 52 can be reduced.

### Third Embodiment

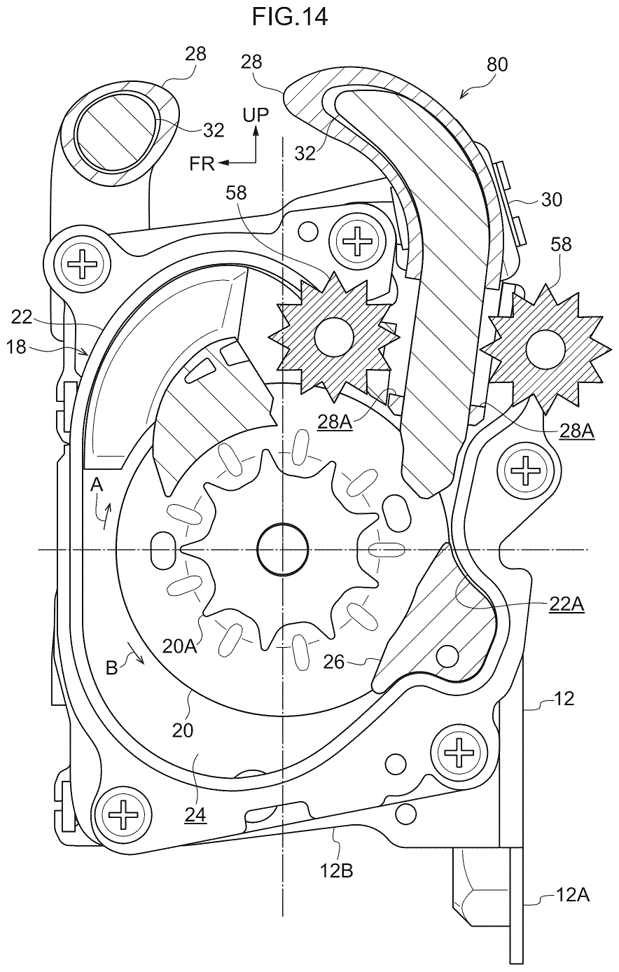

FIG. 14 is a cross-sectional view from the left-hand direction, the view illustrating a pretensioner mechanism 18 of a webbing winding device 80 according to a third embodiment of the present invention.

The webbing winding device 80 according to this embodiment has substantially the same configuration as that of the second embodiment and differs in the following points.

As illustrated in FIG. 14, in the webbing winding device 80 according to this embodiment, the communication hole 28A is also formed to penetrate a rear portion of the distal end portion of the cylinder 28 in the axial direction, and the communication hole 28A on the rear side exposes, to the rear side, the moving member 32 in the cylinder 28.

The torsion shaft 56, the fixed column 72, and the engagement gear 58 are also provided on the rear side of the distal end portion of the cylinder 28 in the axial direction, and the torsion shaft 56 on the rear side rotatably penetrates the leg plate 12B of the frame 12 on the rear side of the distal end portion of the cylinder 28 in the axial direction and can be parallelly displaced frontward with respect to the leg plate 12B. The fixed column 72 on the rear side is movable frontward in a state in which the fixed column is not rotatable with respect to the frame 12, and the fixed inclined surface 72A is formed at a corner portion on the rear side and the left side of the fixed column on the rear side.

The operation cylinder 74 and the piston 50 are also provided behind the torsion shaft 56 on the rear side, and the moving inclined surface 50A is formed at a corner portion on the front side and the right side of the piston 50 on the rear side. The switching MGG 52 communicates with the left sides in the operating cylinders 74 on the front side and the rear side.

Incidentally, at the time of collision of the vehicle when the sensor of the seat detects that the occupant has a small build (at the time of collision detection), the switching MGG 52 is operated in the switching mechanism 34, and the switching MGG 52 instantaneously supplies high-pressure gas into the operation cylinder 74, so that the piston 50 in each operation cylinder 74 is moved rightward by a pressure of the gas, and each fixed column 72 is moved rearward or frontward by sliding performed between the moving inclined surface 50A of each piston 50 and the fixed inclined surface 72A of each fixed column 72. Therefore, when each torsion shaft 56 and each engagement gear 58 are moved rearward or frontward in an integrated manner with each fixed column 72, and teeth of each engagement gear 58 engage with (project into) the moving member 32 in the cylinder 28 via each communication hole 28A of the cylinder 28, each engagement gear 58 is rotated by the movement of the moving member 32. Therefore, when each torsion shaft 56 communicates with the moving member 32, and the left end portion of each torsion shaft 56 is rotated in an integrated manner with each engagement gear 58, each torsion shaft 56 is twisted and deformed, and a load for twisting and deforming each torsion shaft 56 is applied to the moving member 32. This enables the rotational force of the rotation member 20 and the spool 14 in the winding direction A by the movement of the moving member 32 to be decreased and enables the winding force of the webbing 16 around the spool 14 to be decreased (depowered), thereby enabling the restraint force on the occupant of small build by the webbing 16 to be appropriate.

At the time of collision of the vehicle when the sensor of the seat detects that the occupant has a large build (at the time of collision detection), the switching MGG 52 is not operated in the switching mechanism 34, so that the teeth of each engagement gear 58 do not engage with the moving member 32 (see FIG. 14), and each of the torsion shafts 56 does not communicate with the moving member 32. This enables the rotational force of the rotation member 20 and the spool 14 in the winding direction A by the movement of the moving member 32 to be increased, and enables the winding force of the webbing 16 around the spool 14 to be increased (high-powered), thereby enabling the restraint force on the occupant of large build by the webbing 16 to be appropriate.

Here, also in this embodiment, the same operations and effects as those of the second embodiment can be achieved.

Further, the switching MGG 52 is operated, and a load for twisting and deforming the plurality of (two in this embodiment) torsion shafts 56 is applied to the moving member 32. Therefore, a decrease amount of the rotational force of the rotation member 20 and the spool 14 in the winding direction A by the movement of the moving member 32 can be increased, and a decrease amount of the winding force of the webbing 16 around the spool 14 can be increased.

In the second embodiment and the third embodiment, the load for twisting and deforming the torsion shaft 56 is applied to the moving member 32. However, according to the same configuration as that of the modification example of the first embodiment, the load for contracting and deforming the coiled wave spring 64 in the axial direction may be applied to the moving member 32.

### Fourth Embodiment

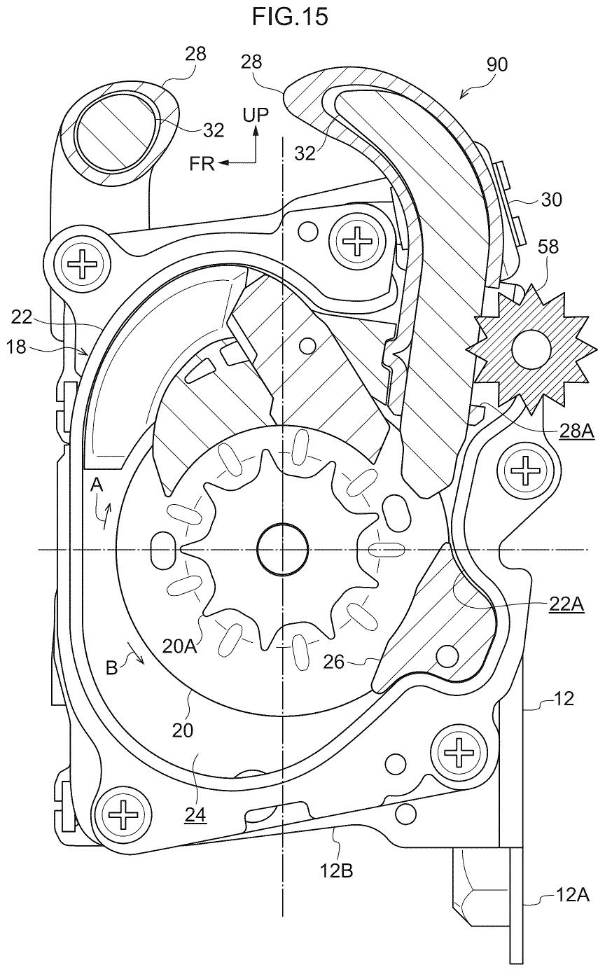

FIG. 15 is a cross-sectional view from the left-hand direction, the view illustrating a pretensioner mechanism 18 of a webbing winding device 90 according to a fourth embodiment of the present invention.

The webbing winding device 90 according to this embodiment has substantially the same configuration as that of the second embodiment and differs in the following points.

As illustrated in FIG. 15, in the webbing winding device 90 according to this embodiment, the communication hole 28A is formed to penetrate the rear portion of the distal end portion of the cylinder 28 in the axial direction, and the communication hole 28A exposes, to the rear side, the moving member 32 in the cylinder 28.

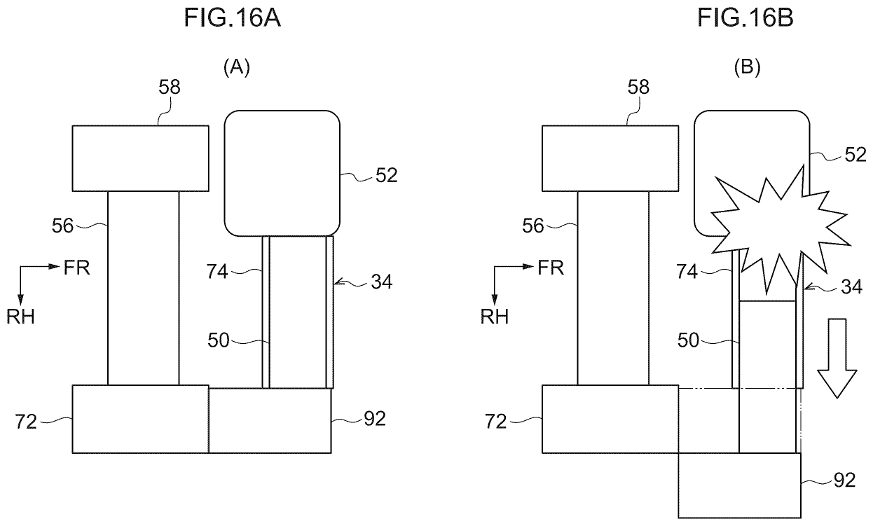

The torsion shaft 56 (see FIG. 16A) penetrates the leg plate 12B of the frame 12 on the rear side of the distal end portion of the cylinder 28 in the axial direction, and the torsion shaft 56 is rotatably supported by the leg plate 12B. The fixed column 72 at the right end portion of the torsion shaft 56 is rotatable with respect to the frame 12, and the teeth of the engagement gear 58 at the left end portion of the torsion shaft 56 engage with (project into) the moving member 32 in the cylinder 28 via the communication hole 28A of the cylinder 28.

A locking column 92 having a rectangular column shape as a locking member is fixed to a right end of the piston 50 in the operation cylinder 74, and the locking column 92 abuts the fixed column 72 to lock the rotation of the fixed column 72 (fix the fixed column 72).

Incidentally, at the time of collision of the vehicle when the sensor of the seat detects that the occupant has a small build (at the time of collision detection), the switching MGG 52 is not operated in the switching mechanism 34, so that the locking column 92 of the piston 50 locks the rotation of the fixed column 72 of the torsion shaft 56 (see FIG. 16A). Therefore, when the engagement gear 58 of the torsion shaft 56 is rotated by the movement of the moving member 32, the torsion shaft 56 is twisted and deformed, and a load for twisting and deforming the torsion shaft 56 is applied to the moving member 32. This enables the rotational force of the rotation member 20 and the spool 14 in the winding direction A by the movement of the moving member 32 to be decreased and enables the winding force of the webbing 16 around the spool 14 to be decreased (depowered), thereby enabling the restraint force on the occupant of small build by the webbing 16 to be appropriate.

At the time of collision of the vehicle when the sensor of the seat detects that the occupant has a large build (at the time of collision detection), the switching MGG 52 is operated in the switching mechanism 34, and the switching MGG 52 instantaneously supplies high-pressure gas into the operation cylinder 74, so that the piston 50 in the operation cylinder 74 is moved rightward by a pressure of the gas, and the locking column 92 of the piston 50 is separated from the fixed column 72 of the torsion shaft 56 (see FIG. 16B). Therefore, when the rotation of the fixed column 72 is not locked (the fixed column 72 is not fixed), the torsion shaft 56 and the fixed column 72 are rotated in an integrated manner with the engagement gear 58, and the torsion shaft 56 is not twisted and deformed, even if the engagement gear 58 is rotated by the movement of the moving member 32. This enables the rotational force of the rotation member 20 and the spool 14 in the winding direction A by the movement of the moving member 32 to be increased, and enables the winding force of the webbing 16 around the spool 14 to be increased (high-powered), thereby enabling the restraint force on the occupant of large build by the webbing 16 to be appropriate.

Here, also in this embodiment, the same operations and effects as those of the second embodiment can be achieved.

In particular, the switching mechanism 34 switches between fixing and non-fixing of the fixed column 72 of the torsion shaft 56. Therefore, the torsion shaft 56 can be deformed by the fixing of the fixed column 72, and the torsion shaft 56 can be made non-deformable by the non-fixing of the fixed column 72.

Further, in the switching mechanism 34, movement and non-movement of the locking column 92 are switched by the switching MGG 52, and fixing and non-fixing of the fixed column 72 of the torsion shaft 56 are switched. Therefore, the switching mechanism 34 can be downsized. Furthermore, the switching MGG 52 only needs to move the piston 50 to move the locking column 92. Therefore, the output of the switching MGG 52 can be reduced, and the costs of the switching MGG 52 can be reduced.

### Fifth Embodiment

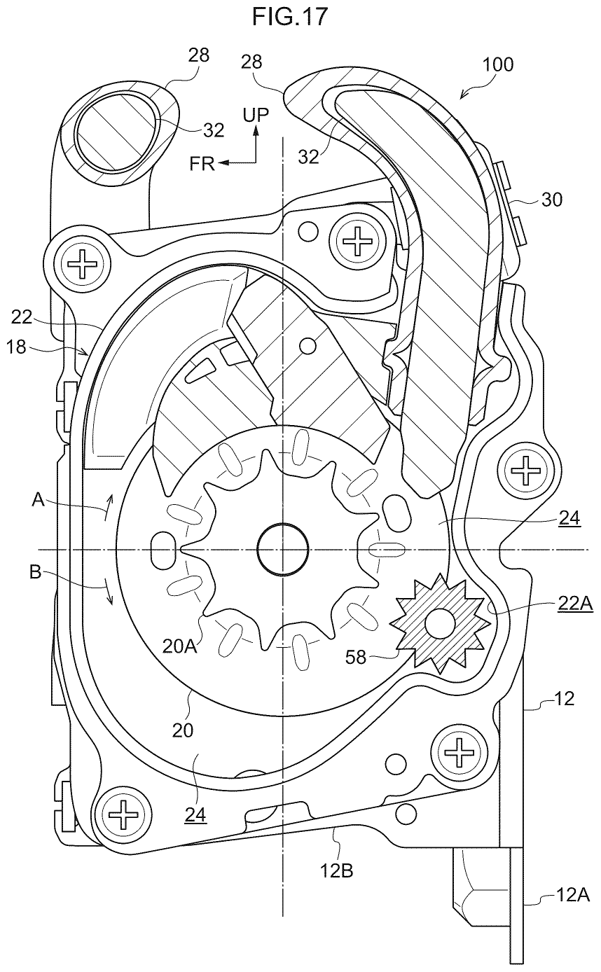

FIG. 17 is a cross-sectional view from the left-hand direction, the view illustrating a pretensioner mechanism 18 of a webbing winding device 100 according to a fifth embodiment of the present invention.

The webbing winding device 100 according to this embodiment has substantially the same configuration as that of the fourth embodiment and differs in the following points.

As illustrated in FIG. 17, in the webbing winding device 100 according to this embodiment, instead of the guide 26, the engagement gear 58 at the left end portion of the torsion shaft 56 is arranged in the arrangement recess portion 22A of the cover plate 22, and the torsion shaft 56 rotatably penetrates the leg plate 12B of the frame 12 at a position in the arrangement recess portion 22A.

The operation cylinder 74, the piston 50, the locking column 92, and the switching MGG 52 are arranged around the torsion shaft 56, and the locking column 92 abuts the fixed column 72 at the right end portion of the torsion shaft 56 to lock the rotation of the fixed column 72 (fix the fixed column 72).

Incidentally, at the time of collision of the vehicle (at the time of collision detection), when the moving member 32 is moved by the operation of the MGG 30, and the engagement teeth 20A at the rear portion of the rotation member 20 engage with (project into) the moving member 32, the teeth of the engagement gear 58 of the torsion shaft 56 engage with (project into) the moving member 32, and the engagement gear 58 is rotated.

Here, also in this embodiment, the same operations and effects as those of the fourth embodiment can be achieved.

What is claimed is:

1. A webbing winding device, comprising:
a spool around which webbing fastened to an occupant is wound by being rotated in a winding direction;
a moving member that is moved to rotate the spool in the winding direction;
a deformation member that is deformable by movement of the moving member; and
a switching mechanism that switches between deformation and non-deformation of the deformation member by the movement of the moving member.

2. The webbing winding device according to claim 1, wherein the switching mechanism switches between communication and non-communication of the deformation member with the moving member.

3. The webbing winding device according to claim 2, wherein the deformation member communicates with the moving member via the spool.

4. The webbing winding device according to claim 2, wherein the switching mechanism includes:
a communication member by which the deformation member communicates with the moving member, and
a restriction member that switches between restriction and non-restriction of communication of the deformation member with the moving member by the communication member.

5. The webbing winding device according to claim 1, wherein the switching mechanism switches between fixing and non-fixing of the deformation member.

6. The webbing winding device according to claim 1, wherein the deformation member is twisted and deformed.

7. The webbing winding device according to claim 1, wherein the deformation member is elastically deformed.

8. The webbing winding device according to claim 2, wherein the deformation member communicates with the moving member without communicating via the spool.

9. The webbing winding device according to claim 1, wherein a plurality of deformation members are provided.
